(19) United States
(12) Patent Application Publication
(10) Pub. No.: US 2004/0026872 A1
(43) Pub. Date: Feb. 12, 2004

(54) Assembly for sealing and centering in a two-cylinder dashpot or two-cylinder telescoping leg

(76) Inventors: Adolf Adrian, Ennepetal (DE); Andreas Nevoigt, Hagen (DE); Dirk Feist, Herne (DE); Jurgen Fabelji, Ennepetal (DE)

Correspondence Address: Dr. Max Fogiel, 61 Ethel Road West, Piscataway, NJ, 08854, US

(21) Appl. No.: 10/612,635

(22) Filed: Jul. 2, 2003

(30) Foreign Application Priority Data
Jul. 6, 2002 (DE) 102 30 499.8

(51) Int. Cl. F16J 9/20

(52) U.S. Cl. 277/437

(57) ABSTRACT

An assembly for sealing and centering a piston rod (3) at its point of penetration in a two-cylinder dashpot or two-cylinder telescoping leg. The assembly seals and centers it as the piston rod travels into and out of the dashpot. The assembly is provided with at least one seal (13) outside the dashpot, toward the inside with at least one piston-rod sealing ring (7), and with at least one channel between them. The channel extends into a gas accommodating space (19) left between the dashpot's outer cylinder (1) and its inner cylinder (2). The gas channel is provided with a checkvalve. One object is components that eliminate the need for a high-pressure sealing ring in contact with the piston rod. Another object is a simpler checkvalve in the overflow channel. The gas channel upstream of the gas-accommodating space is provided with a flow-controlling diaphragm (22).

The present invention concerns an assembly for sealing and centering a piston rod in a two-cylinder dashpot or two-cylinder telescoping leg as recited in claim 1.

In a two-cylinder dashpot, a piston rides up and down on the inside end of a piston rod that travels into and out of an inner cylinder. The piston rests more or less tight against the inner surface of the cylinder, demarcating a fluid-filled compression chamber. The fluid absorbs the incoming shock. An accommodation in the form of a cushion of gas at the top of the gap between the two cylinders compensates for the varying volume of the piston rod as it travels in and out.

To ensure reliable and smooth shock absorption, especially when the piston rod is moving very rapidly, the shock-absorbing fluid is generally supplied compressed. Pressures of 3 to 8 bars are normal.

A component called a piston-rod sealing-and-centering assembly is provided at the top of the overall device to radially position the piston rod in relation to the inner and outer cylinders and to seal it off from the environment. This assembly comprises an outward-facing piston-rod sealing ring and an inward-facing piston-rod centering ring resting against the inward-facing face of the sealing ring.

Gas, however, can leak out of the gas accommodation into the inner cylinder's chambers. A checkvalve is accordingly provided between the piston-rod centering ring and the piston-rod sealing ring, communicating with the gas accommodation to allow the escaped material to return therein.

A piston-rod sealing-and-centering assembly of this genus is known from German 2 832 640 A1. It entails the drawback, however, that the situation of the checkvalve between the piston rod and the gas accommodation considerably complicates the design. Another drawback is that the “high-pressure sealing ring” between the piston-rod centering ring and the piston-rod sealing ring is in contact with the rod and accordingly causes friction.

One object of the present invention is accordingly components of a piston-rod sealing-and-centering assembly of the aforesaid genus designed and arranged to eliminate the need for a high-pressure sealing ring in contact with the piston rod. Another object is a simpler checkvalve in the overflow channel.

This object is attained in accordance with the present invention in a piston-rod sealing-and-centering assembly with the characteristics recited in claim 1. Alternative and advanced embodiments are addressed by claims 2 through 4.

The advantages of the present invention derive in particular from the low-friction and wear-resistant material employed for the piston-rod sealing ring. The piston-rod sealing ring can accordingly be unobjectionably subjected to high pressure just during the decompression phase, eliminating the need for a particularly high-pressure tightness between the cylinder and the piston-rod sealing ring. This approach will considerably decrease the friction between the piston-rod sealing ring and the piston rod and hence the dashpot's tendency to stick and slip.

One embodiment of the present invention will now be specified with reference to the attached drawing, wherein

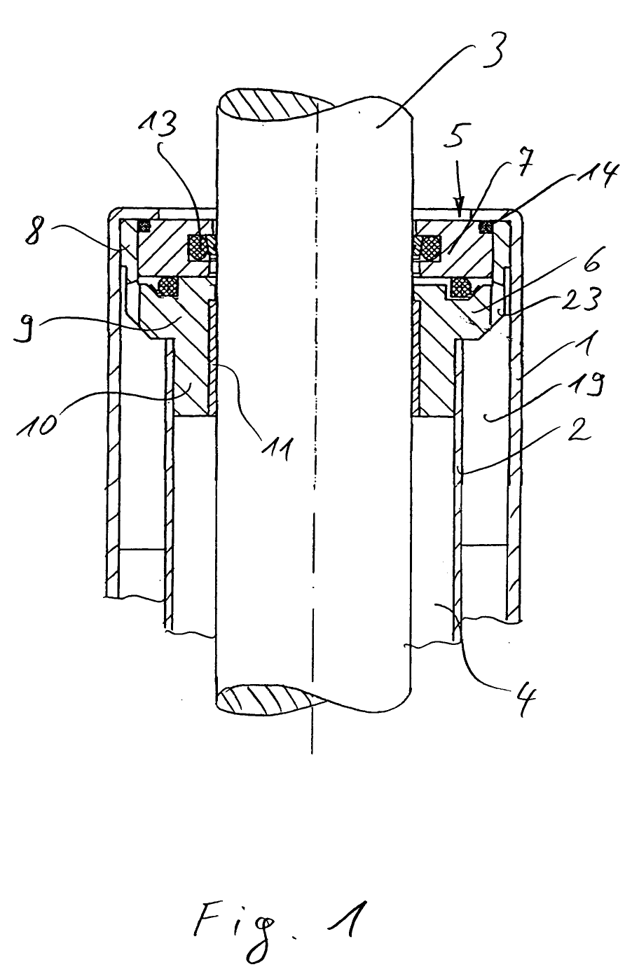

FIG. 1 is a section through the vicinity of a piston-rod sealing-and-centering assembly in a two-cylinder dashpot, and

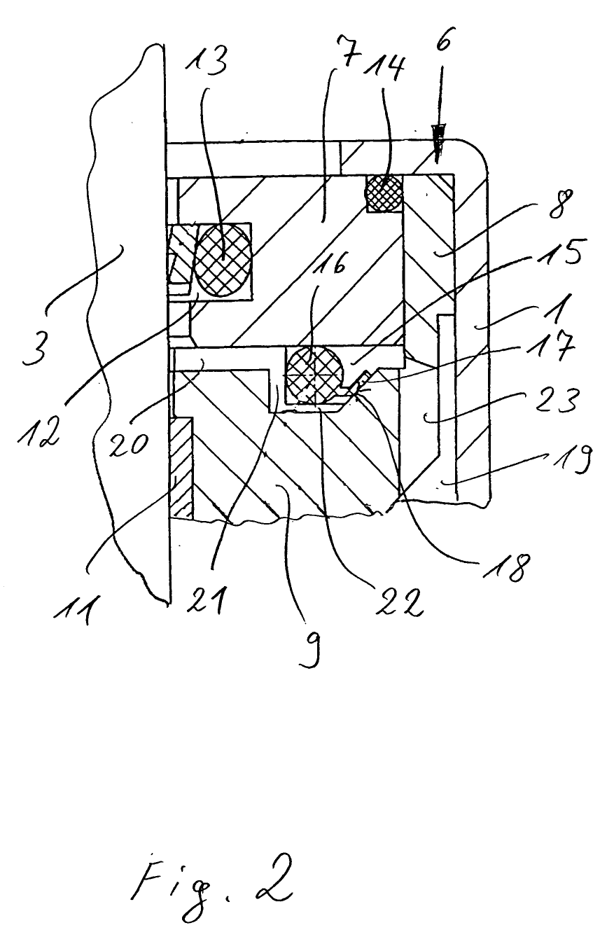

FIG. 2 a larger-scale section through half of the piston-rod sealing-and-centering assembly depicted in FIG. 1.

The housing of a two-cylinder dashpot or telescoping leg (whereby the former term shall be understood to refer to either device hereinafter) comprises two co-axial cylinders, an outer cylinder 1 and an inner cylinder 2. A piston rod 3 travels into and out of the housing through its top, which is open. Mounted on the end of piston rod 3 inside the housing is an unillustrated piston that rests against the inner surface of inner cylinder 2, demarcating a fluid-filled pressure-application chamber 4 and generating the shock-absorbing force by way of valve-controlled ports.

The moving piston rod 3 is sealed off from and centered in relation to the housing by a piston-rod sealing-and-centering assembly 5. The assembly illustrated in FIGS. 1 and 2 essentially comprises a piston-rod centering ring 6 and a piston rod sealing ring 7 in the form of a gasket. The wall of piston-rod centering ring 6 is approximately Z-shaped in cross-section. At upper end 8, it rests with its outside circumference against the inner surface of outer cylinder 1, decreases at a midpoint 9 to form a more or less sleeve-like structure with an inner circumference approximately matching the diameter of piston rod 3, and extends axially inward at lower end 10, its outer circumference resting against the inner surface of inner cylinder 2. Mounted on the inner surface of the piston-rod centering ring 6 in the illustrated example is a bushing 11 that radially secures piston rod. It would alteratively be conceivable for piston rod 3 to rest radially directly against the inner surface of piston-rod centering ring 6.

Piston-rod sealing ring 7 fits into a flowerpot-shaped accommodation at the upper end 8 of piston-rod centering ring 6. The inner surface of piston-rod sealing ring 7 is provided with a radially inward open groove 12 accommodating a multiple-part seal 13 that seals off sealing-and-centering assembly 5 and hence the dashpot housing from piston rod 3. Another seal, seal 14, seals off sealing-and-centering assembly 5 from outer cylinder 1, which is upset at its upper end to axially secure the dashpot's components.

A venting system is illustrated in larger scale in FIG. 2. The outer circumference of the base of the flowerpot-shaped accommodation is provided with a continuous groove 15 that can accommodate a special seal 16. The main cross-section of seal 16 is round, and the seal is provided with a lip 17 that extends radially outward at the bottom. Unstressed, lip 17 rests against a conical surface 18 of groove 15. Seal 16 is inserted with its main cross-section in the groove between piston-rod centering ring 6 and piston-rod sealing ring 7. Various channels that will be specified in greater detail hereinafter act as venting components that create a one-way communication between the section between sliding bushing 11 and seal 13 on the one hand and a gas accommodating space 19 on the other. Gas-accommodating space 19 is at the top of the gap between inner cylinder 2 and outer cylinder 1. Below it, and in pressure-application chamber 4 as well, is shock-absorbing fluid.

Any bubbles of gas or leaking oil between bushing 11 and seal 13 will be conveyed to gas-accommodating space 19 through a series of channels. This system consists essentially of channels 20, 21, and 22 that extend radially from the inner surface to the outer surface of piston-rod centering ring 6. They extend, open at the top, either along the base of the accommodation in piston-rod centering ring 6 that accepts piston-rod sealing ring 7 or along the base of groove 15 below the main cross-section of seal 16. Channel 22 no longer extends into the conical surface 18 that lip 17 rests against. Groove 15 communicates with gas-accommodating space 19 through local apertures 23.

As will be evident from FIG. 2, lip 17 acts in conjunction with conical surface 18 as a checkvalve, preventing the gas in gas accommodating space 19 from penetrating between bushing 11 and seal 13.

The resilience and shape of lip 17 provide, along with variations in the dimensions and number of radial channels 20, 21, and 22, simple means of adjusting the performance of the venting system to various needs. The diaphragm effect provided by the channel 22 below seal 16 in particular ensures that the performance will be constant independent of manufacturing tolerances.

1. Assembly for sealing and centering a piston rod (3) at its point of penetration in a two-cylinder dashpot or two-cylinder telescoping leg, whereby the assembly seals and centers it as the piston rod travels into and out of the dashpot and is provided with at least one seal (13) outside the dashpot, toward the inside with at least one piston-rod sealing ring (7), and with at least one channel between them extending into a gas-accommodating space (19) left between the dashpot's outer cylinder (1) and its inner cylinder (2) and whereby the gas channel is provided with a checkvalve, characterized in that the gas channel upstream of the gas-accommodating space is provided with a flow-controlling diaphragm (22)

2. Assembly as in claim 1, characterized in that the checkvalve constitutes a seal provided with a lip.

3. Assembly as in as 1 or 2, characterized in that the diaphragm is a bore.

4. Assembly as in claim 1 or 2, characterized in that the lipped seal is itself a sealing lip (17) integrated into an elastically tensioned ring with a more or less circular wall cross-section and in that the diaphragm comprises one (22) or more depressions in a seat below the elastically tensioned ring.
